(19) United States
(12) Patent Application Publication
(10) Pub. No.: US 2013/0015637 A1
(43) Pub. Date: Jan. 17, 2013

(54) HITCH INSERT APPARATUS

(71) Applicant: Loren Siebrandt, West Point, NE (US)

(72) Inventor: Loren Siebrandt, West Point, NE (US)

(21) Appl. No.: 13/625,054

(22) Filed: Sep. 24, 2012

Related U.S. Application Data
(63) Continuation-in-part of application No. 13/465,175, filed on May 7, 2012.
(60) Provisional application No. 61/483,283, filed on May 6, 2011.

(51) Int. Cl. B60R 9/06

(52) U.S. Cl. 280/495

(57) ABSTRACT

A hitch insert apparatus for attaching with a vehicular trailer hitch for providing a stair assembly with alternative positioning for providing a support surface. The hitch insert apparatus generally includes a plurality of steps and a horizontal support member for coupling between the steps and the vehicular trailer hitch.

### CROSS-REFERENCE TO RELATED APPLICATIONS

The present application claims the benefit under 35 U.S.C. §120 to U.S. application Ser. No. 13/465,175, filed May 7, 2012, which claims the benefit under 35 U.S.C. §119(e) of U.S. Provisional Application Ser. No. 61/483,283, filed May 6, 2011. Said U.S. application Ser. No. 13/465,175 and said U.S. Provisional Application Ser. No. 61/483,283 are herein incorporated by reference in their entireties.

### FIELD

The present disclosure generally relates to the field of vehicular utility accessories, and more particularly to an apparatus for attaching with a vehicular trailer hitch for providing a stair assembly with alternative positioning for providing a support surface.

### BACKGROUND

Automobiles and other vehicles, including trucks, sport utility vehicles, cross-over vehicles, trailers, and camping vehicles, often include a trailer hitch or trailer hitch reception port near a utility area of the vehicle, such as a truck bed. It is often desirable for an individual to physically enter the utility area of the vehicle in order to access the extra storage space afforded by the utility area. Moreover, the utility area of the vehicle may be positioned relatively high above the ground, such as above a rear bumper of the vehicle. Access to the utility area of the vehicle therefore may require an individual to exert effort to overcome the vertical positioning of the utility area by stepping, climbing, etc., into the utility area. This effort may become substantial, depending on the age of the individual, the weight of the individual, the amount of materials being carried into/out of the utility area of the vehicle, and the like.

It is therefore desirable to provide access to the utility area of a vehicle which provides ease of access and which does not require substantial modification of the vehicle.

### SUMMARY

Accordingly, in one implementation, the present disclosure provides an adjustable hitch insert device comprising: a plurality of steps, each step of the plurality of steps including two opposing sides. The device also includes a first pair of stair supports, each of the first pair of stair supports operably coupled to one opposing side of each of the plurality of steps. The device further includes a second pair of stair supports, each of the second pair of stair supports operably coupled to one opposing side of each of the plurality of steps, the second pair of stair supports adjacent the first pair of stair supports. The device further includes a horizontal support member coupled to at least one step of the plurality of steps. The horizontal support member includes a horizontal support portion; and an extendable portion configured to move longitudinally relative to the horizontal support portion. The plurality of steps, the first pair of stair supports, and the second pair of stair supports are configured to transition between a collapsed orientation, where each step of the plurality of steps is in a substantially same plane, and an expanded orientation, where each step of the plurality of steps is in a substantially different plane.

In another implementation, the present disclosure provides a hitch insert assembly comprising: a stair assembly. The stair assembly includes: a plurality of steps, each step of the plurality of steps including two opposing sides, each step of the plurality of steps being positioned in a plane that is different than a plane of the other steps of the plurality of steps. The stair assembly also includes a pair of side rails, each of the pair of side rails operably coupled to one opposing side of each of the plurality of steps. The hitch insert assembly also includes a connector portion coupled to a step of the plurality of steps of the stair assembly, the connector portion being positioned between each side rail or the pair of side rails. The hitch insert assembly further includes a horizontal support member, the horizontal support member including a first end and a second end, the first end configured for coupling with a hitch of a vehicle, the second end configured for removeably coupling with the connector portion. The hitch insert assembly further includes a handle mount coupled to the stair assembly, the handle mount defining an aperture configured to receive a handle lever.

It is to be understood that both the foregoing general description and the following detailed description are exemplary and explanatory only and are not necessarily restrictive of the disclosure as claimed. The accompanying drawings, which are incorporated in and constitute a part of the specification, illustrate an embodiment of the disclosure and together with the general description, serve to explain the principles of the disclosure.

### BRIEF DESCRIPTION OF THE DRAWINGS

The numerous advantages of the present disclosure may be better understood by those skilled in the art by reference to the accompanying figures in which:

FIG. 1A is a top plan view of an adjustable apparatus according to one implementation of the present disclosure;

FIG. 1B is a side view of the adjustable apparatus of FIG. 1A in a collapsed orientation;

FIG. 2A is a side view of the adjustable apparatus of FIG. 1A in an extended orientation, extending beyond an open gate of a vehicle;

FIG. 2B is a side view of the adjustable apparatus of FIG. 1A in a retracted orientation, with the gate of the vehicle in a closed position;

FIG. 2C is a side view of the adjustable apparatus of FIG. 1A in an alternative position providing an additional support surface beyond an open gate of the vehicle;

FIG. 3 is a perspective view of the adjustable apparatus of FIG. 1A in a retracted orientation, with the gate of the vehicle in a closed position;

FIG. 4 is a front view of the adjustable apparatus of FIG. 1A in a retracted orientation, with the gate of the vehicle in a closed position;

FIG. 5 is an isometric view of a hitch insert assembly according to another implementation of the present disclosure;

FIG. 6 is a perspective view of the underside of the hitch insert asserting of FIG. 5; and

FIG. 7 is a perspective view of a handle insert of the hitch insert asserting of FIG. 5.

### DETAILED DESCRIPTION

Reference will now be made in detail to the presently preferred embodiments of the present disclosure, examples of which are illustrated in the accompanying drawings.

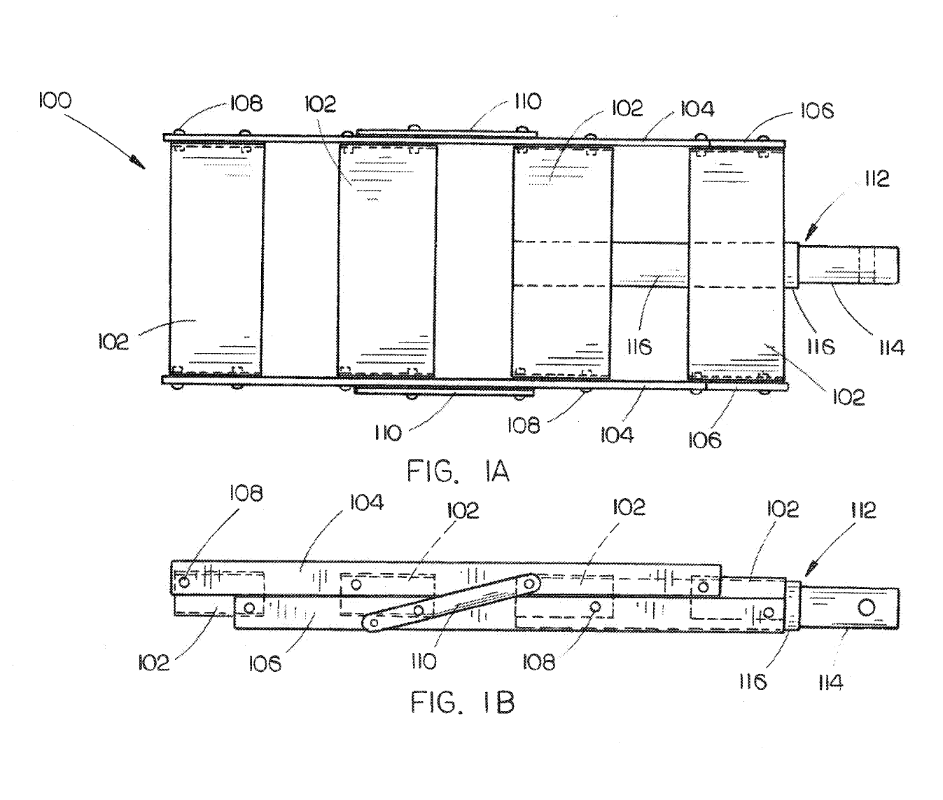

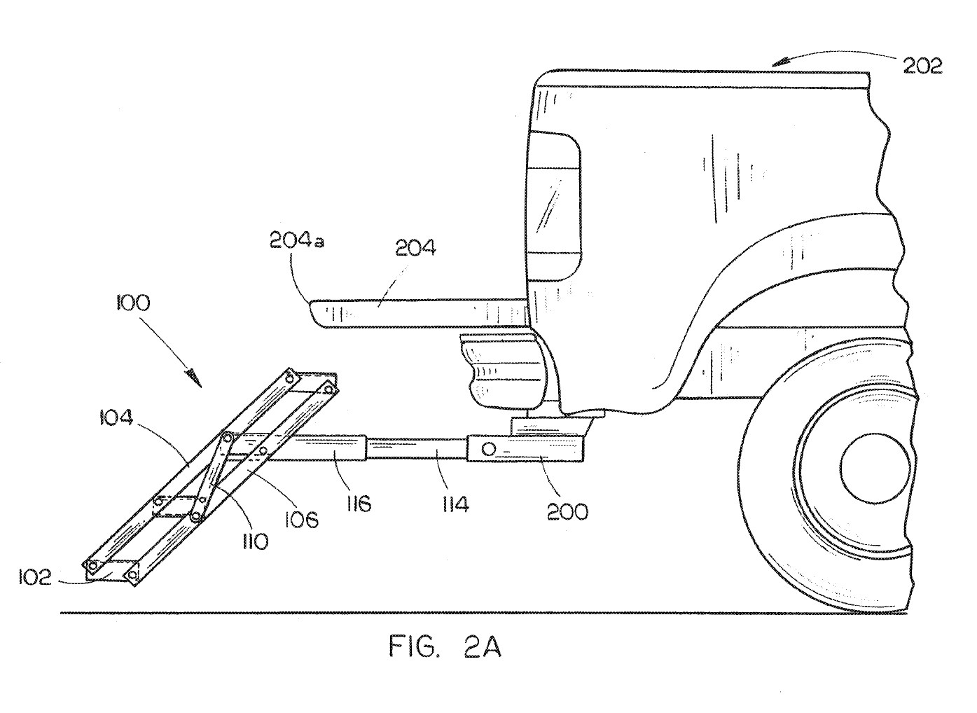

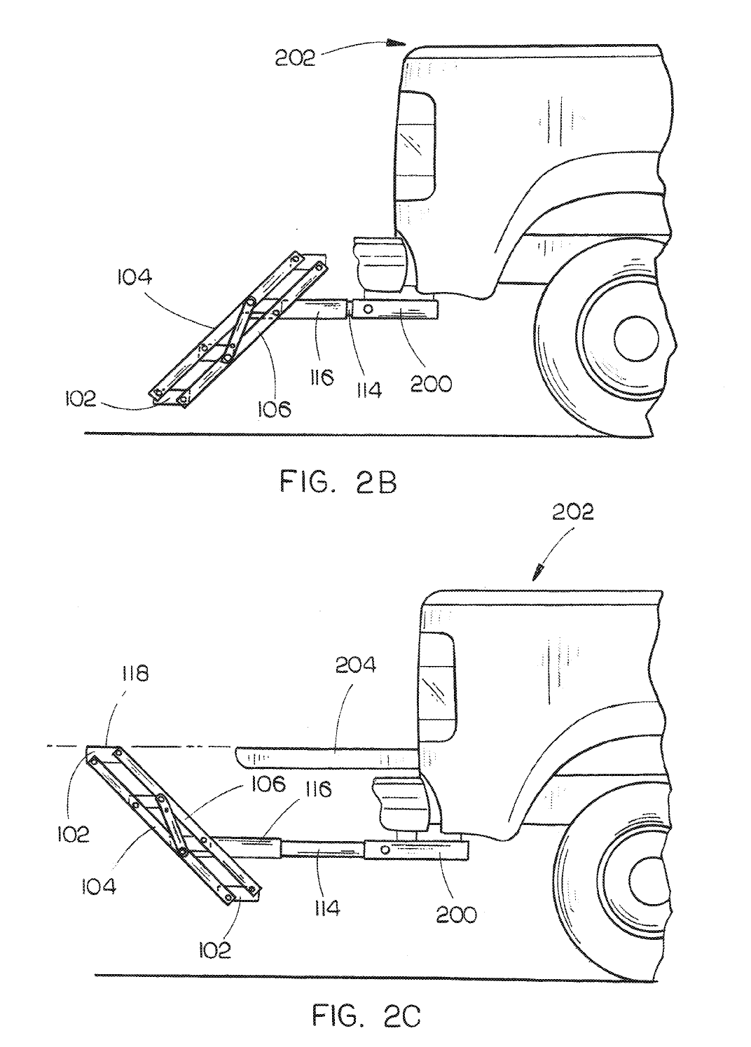

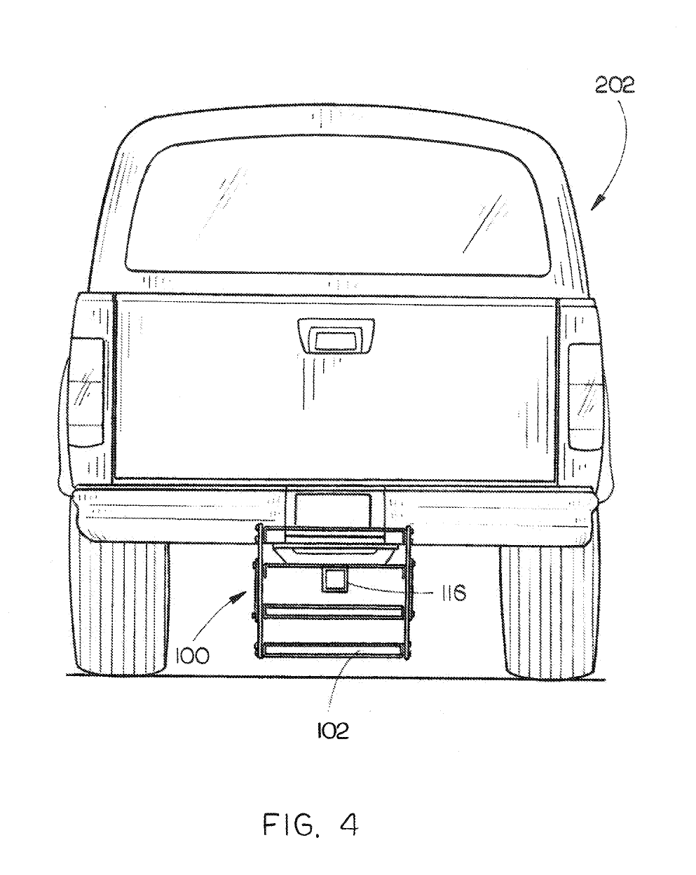

Referring to FIG. 1A, a top plan view of an adjustable apparatus 100 according to one implementation of the present disclosure is shown. The apparatus 100 includes a plurality of collapsible steps 102, that, when collapsed (as shown in FIG. 1B), are generally positioned in substantially the same plane. In a particular implementation, each collapsible step 102 is coupled to a first pair of stair supports 104 and a second pair of stair supports 106. Each collapsible step 102 may be coupled to the first pair of stair supports 104 and the second pair of stair supports 106 via a suitable fastener or coupling 108, such as a bolt/nut configuration, a rivet, or other fastener coupling. The coupling 108 between the collapsible step 102 and the first pair of stair supports 104 and the second pair of stair supports 106 may enable the step 102 to rotate relative to the first pair of stair supports 104 and the second pair of stair supports 106 such that the apparatus 100 may transition between a collapsed orientation (e.g., as shown in FIG. 1B), where the collapsible steps 102 are substantially planar, and an expanded orientation (e.g., as shown in FIGS. 2A, 2B, 2C, 3, and 4), where the collapsible steps 102 are in different planes thereby forming a usable staircase.

The apparatus 100 may also include one or more interlocking members 110 coupled between stair support 104 and stair support 106. The interlocking members 110 are preferably configured for rotatable coupling between stair support 104 and stair support 106 to permit the apparatus 100 to transition between the collapsed orientation and the expanded orientation. The interlocking members 110 may also restrict the amount of rotation of the steps 102, such that the stair supports 104 and 106 rotate from a parallel orientation relative to the horizontal support member 112 (when in the collapsed orientation) to a non-perpendicular orientation relative to the horizontal support (when in the expanded orientation) to provide a non-vertical staircase for use by an individual.

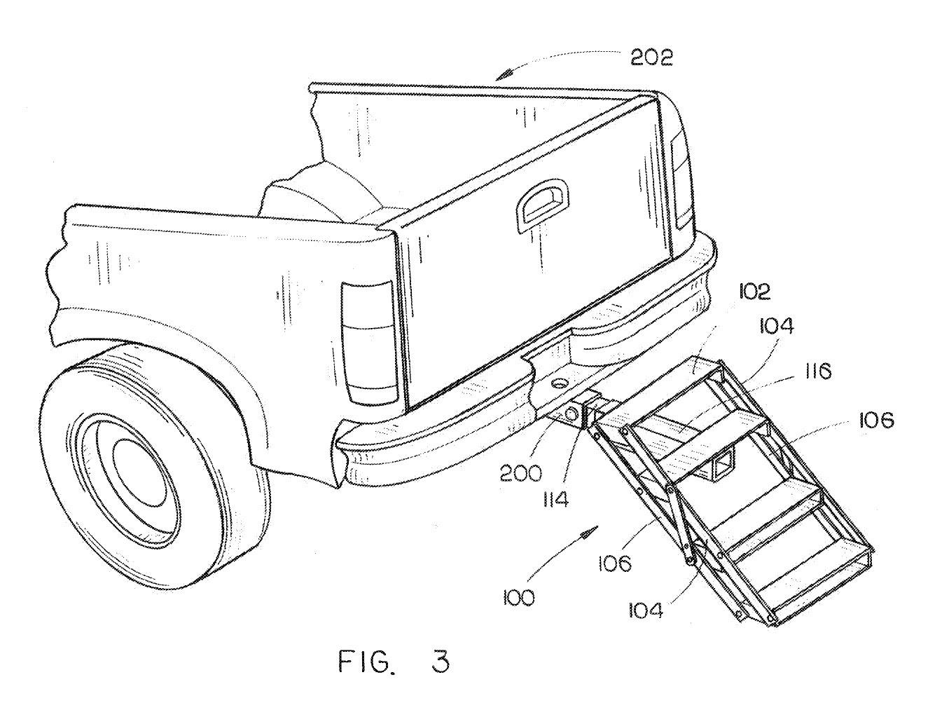

The apparatus 100 may also include a horizontal support member 112 coupled to at least one step 102. In a preferred implementation, the apparatus 100 includes four steps 102, where the horizontal support member 112 is coupled to the second highest step 102 when the apparatus 100 is in the expanded orientation. When the apparatus 100 is in the collapsed orientation, the horizontal support member 112 is preferably in substantially the same plane as the steps 102 (as shown in FIG. 1B). The horizontal support member 112 may include a first end 112a and a second end 112b, with the first end 112a being configured for coupling with a vehicle hitch, and with the second end 112b being coupled to one step 102. In a preferred implementation (shown in FIGS. 2A-3), the first end 112a is sized such that the first end 112a couples to (e.g., fits within) a hitch 200 of a vehicle 202. In general, the first end 112a is configured to provide a secure coupling with the hitch 200 to provide stability to the apparatus 100 during use by an individual.

The horizontal support member 112 may also include an extendable portion 114 that moves longitudinally relative to a horizontal support portion 116, such that the horizontal support member 112 may transition between a retracted orientation (as shown in FIGS. 1A, 1B, 2B, and 3) and an extended orientation (as shown in FIGS. 2A and 2C), where extendable portion 114 longitudinally extends beyond its position in the retracted orientation. The first end 112a of the horizontal support member 112 may define an aperture through which a locking pin, rod, or other device suitable for coupling the first end 112a to the hitch 200 is inserted to lock the horizontal support member 112 in place relative to the vehicle 202. The horizontal support member 112 may include a similar aperture through each of the extendable portion 114 and the horizontal support portion 116 (not shown) to lock the extendable portion 114 in place relative to the horizontal support portion 116 with a locking pin, rod, or the like. It is contemplated that the extendable portion 114 may define several such apertures to provide an operator of apparatus 100 with the option to lock the extendable portion 114 relative to the horizontal support portion 116 at a desired length of the horizontal support member 112 between the steps 102 and the position of the vehicle 202.

Referring to FIG. 2A, the horizontal support member 112 is shown in the extended orientation, with the first end 112a coupled to the hitch 200 of the vehicle 202. When the horizontal support member 112 is in the extended orientation and when the apparatus 100 is in the expanded orientation, the steps 102 are positioned to accommodate a gate 204 of the vehicle 202 in an open position, such that a plurality of steps 102 extend beyond an outer edge 204a of the gate 204. The apparatus 100 therefore allows access to a utility area of the vehicle 202, such as a truck bed, cargo area, camper interior, or the like, when the horizontal support member 112 is in the extended orientation and when the apparatus 100 is in the expanded orientation.

Referring to FIGS. 2B, 3, and 4, the horizontal support member 112 is shown in the retracted orientation, with the first end 112a coupled to the hitch 200 of the vehicle 202. With the gate 204 of the vehicle 202 in a closed position, the steps 102 are positioned closer to a bumper 206 of the vehicle 202 when the horizontal support member 112 is in the retracted orientation than when the horizontal support member 112 is in the extended orientation. The apparatus 100 therefore allows ease of access to the bumper 206 and surrounding areas of the vehicle 202 when the horizontal support member 112 is in the retracted orientation and when the apparatus 100 is in the expanded orientation.

Referring to FIG. 2C, the apparatus 100 is shown in an alternative position providing an additional support surface 118 beyond the gate 204 of the vehicle 202 in the open position. In order to orient the apparatus 100 in the alternative position, the apparatus 100 is rotated approximately 180 degrees from the position shown in FIG. 2A, such that the step 102 distal the horizontal support member 112 provides the additional support surface 118. For instance, in one particular implementation, the additional support surface 118 is substantially in the same plane as the gate 204 of the vehicle 202 in the open position. While FIG. 2C shows the horizontal support member 112 in the extended orientation, it is contemplated that the alternative position of the apparatus 100 may also occur with the horizontal support member 112 in the retracted orientation, which may bring the additional support surface 118 closer to the gate 204 of the vehicle 202 than when the horizontal support member 112 in the extended orientation.

It is contemplated that the steps 102 may include a slip-resistant surface, such as by treatment of the material comprising the step 102 (e.g., increasing the surface area of the step 102 relative to the dimensional area of the surface of the step 102, such as by pitting, scratching, adding grooves, and the like), or by addition of another material to the step 108 (e.g., a slip-resistant coating, such as a textured epoxy coating, a textured acrylic coating, a silica/grit coating, or other suitable coating).

The apparatus 100 is preferably constructed from a durable material, such as steel, steel alloys, aluminum, aluminum alloys, plastic, carbon fiber, or other suitable material. In a preferred implementation, the steps 102, the interlocking members 110, and the horizontal support member 112, comprise aluminum or an aluminum alloy.

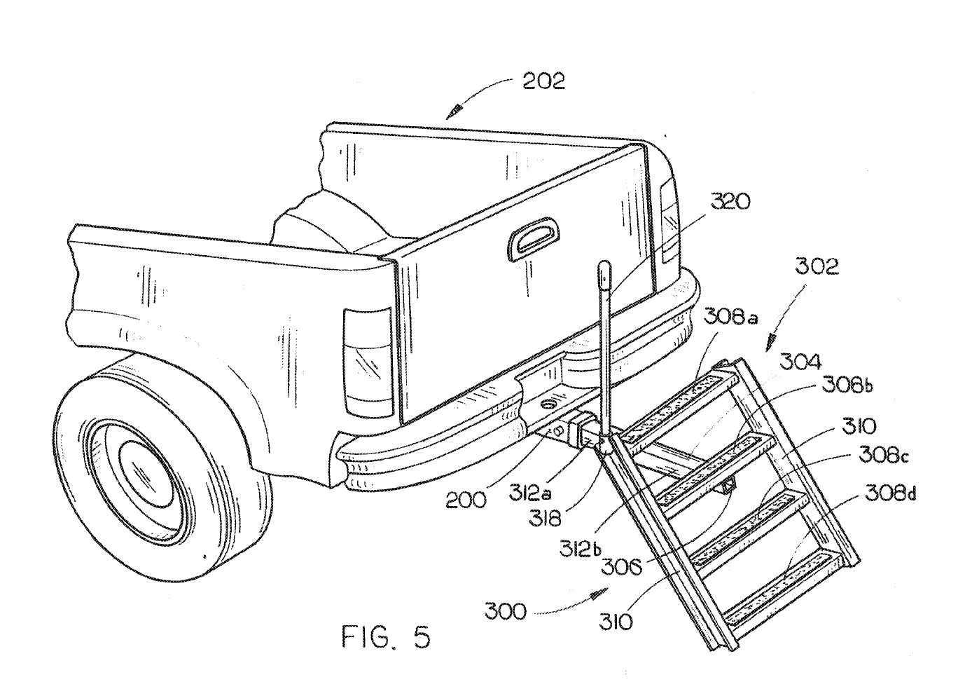

Referring now to FIGS. 5-7, a hitch insert assembly 300 is shown according to another implementation of the present disclosure. The hitch insert assembly 300 may include a stair assembly 302, a horizontal support member 304, and a connector portion 306. The stair assembly 302 may include a plurality of steps 308 (e.g., steps 308a, 308b, 308c, and 308d). The stair assembly may further include a pair of side rails 310 to which each step 308 is connected to form a usable stairway. In the implementation shown in FIGS. 5-7, the stair assembly 302 includes four steps 308a, 308b, 308c, and 308d, however it is contemplated that a fewer or greater number of steps 308 may be utilized depending on a preferred implementation of the hitch insert assembly 300.

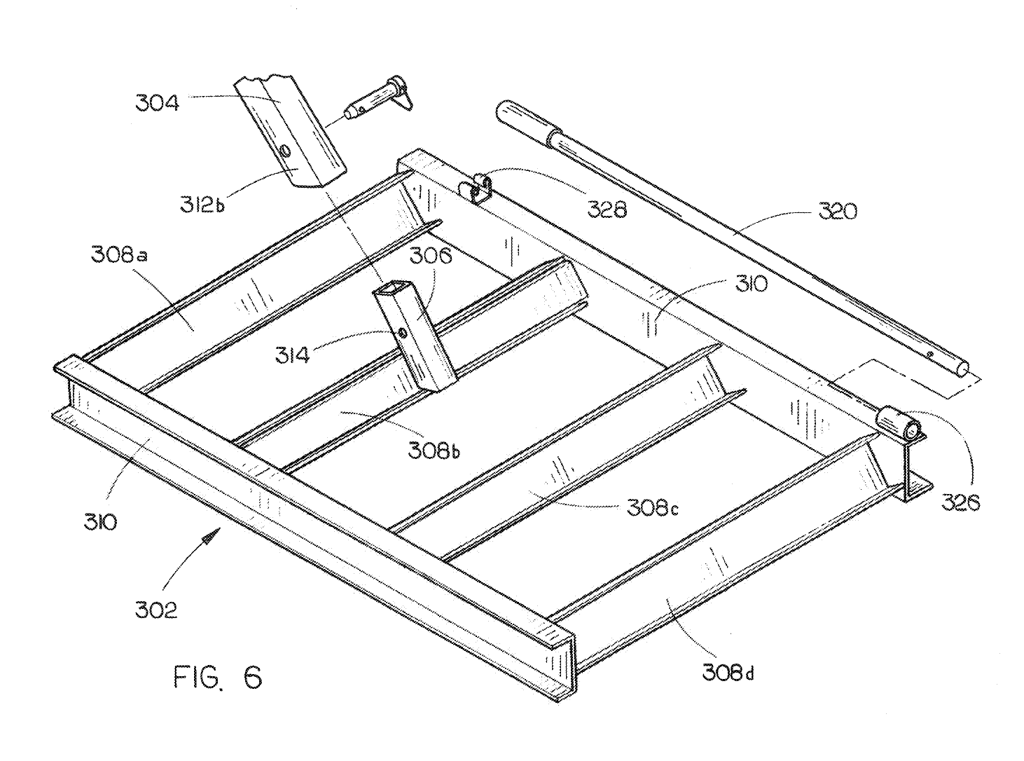

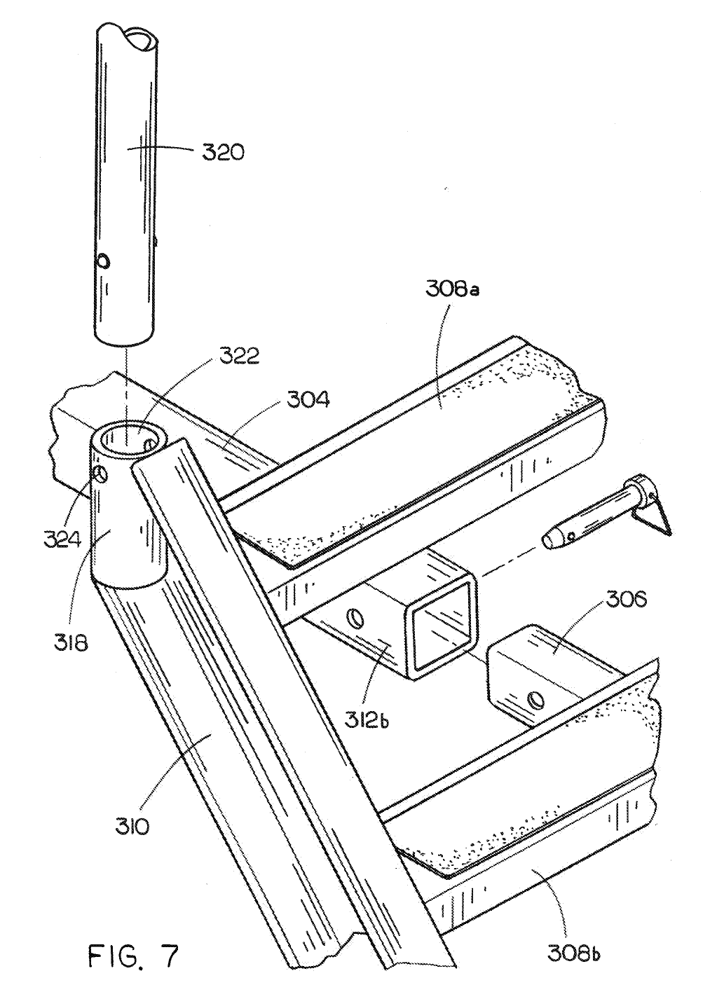

The connector portion 306 is configured to connect the horizontal support member 304 to the stair assembly 302. The horizontal support member 304 may define a hollow structure, such as a rectangular tube or other structural shape, and may include a first end 312a and a second end 312b. The first end 312a may be configured for coupling with the vehicle hitch 200, and the second end 312b may be configured for coupling with the connector portion 306. For instance, the connector portion 306 may fit within the hollow structure of the horizontal support member 304 at the second end 312b. Alternatively, the connector portion 306 may define a hollow structure into which at least a portion of the horizontal support member 304 at the second end 312b fits. The connector portion 306 may define an aperture 314 through which a locking pin, rod, or other device suitable for coupling the connector portion 306 with the horizontal support member 304 is inserted to lock the horizontal support member 304 in place relative to the connector portion 306. The second end 312b of the horizontal support member 304 may define a corresponding aperture (not shown) to align with aperture 314 to lock the horizontal support member 304 in place relative to the connector portion 306. The connector portion 306 may be coupled to a step 308 of the stair assembly 302. For instance, as shown in FIG. 6, the connector portion 306 is coupled to the underside of step 308b via mating member 316. It is contemplated that other/different connections between the connector portion 306 and the stair assembly 302 may be made, including but not limited to, connections between the side rails 310 and the connector portion 306 without connection to a particular step 308. It is also contemplated that the hitch insert assembly 300 is suitable for being positioned in the alternative position as illustrated by FIG. 2A regarding apparatus 100.

The hitch insert assembly 300 may include a handle mount 318 and a handle lever 320 configured to removeably mate with the handle mount 318. For instance, the handle mount 318 may define an aperture 322 into which the handle lever 320 is configured to fit. The handle mount 318 may also define one or more apertures 324 which a fastener may engage the aperture 324 to mate the handle mount 318 and the handle lever 320. In a particular implementation, the handle lever 320 includes a ball plunger fastener to removeably mate with the aperture 324 of the handle mount 318. The handle mount 318 is preferably secured to the stair assembly 302 to permit an individual to insert the handle lever 320 into the handle mount 318 to provide stability while traversing the steps 308. In a particular implementation, the handle mount 318 is secured to one side rail 310 of the stair assembly 302. It is contemplated that the handle mount 318 may be secured elsewhere on the stair assembly 302, including but not limited to direct coupling to a step 308. It is also contemplated that more than one handle lever 320 and handle mount 318 may be incorporated into the hitch insert assembly 300, such as providing a separate handle lever 320 and handle mount 318 for each side rail 310. It is further contemplated that the apparatus 100 of FIGS. 1A-4 may also include a handle and handle mount similar to the handle lever 320 and the handle mount 318 of FIGS. 5 and 7.

The hitch insert assembly 300 may include a handle storage mount 326 and a handle storage clip 328 (as shown in FIG. 6) to store the handle lever 320, such as during transport of the hitch insert assembly 300. In a particular implementation, the handle storage mount 326 and the handle storage clip 328 are secured to one side rail 310 of the stair assembly 302, such that the handle lever 320 may be secured adjacent the side rail 310 in a substantially parallel alignment.

The steps 308 of the stair assembly 302 may include a slip-resistant surface, such as by treatment of the material comprising the step 308 (e.g., increasing the surface area of the step 302 relative to the dimensional area of the surface of the step 302, such as by pitting, scratching, adding grooves, and the like), or by addition of another material to the step 308 (e.g., a slip-resistant coating, such as a textured epoxy coating, a textured acrylic coating, a silica/grit coating, or other suitable coating). The steps 308 shown in FIGS. 5 and 7 are shown with a slip-resistant coating applied to the steps 308.

The hitch insert assembly 300 is preferably constructed from a durable material, such as steel, steel alloys, aluminum, aluminum alloys, plastic, carbon fiber, or other suitable material. In a preferred implementation, the stair assembly 302, the connector portion 306, and the horizontal support member 304 comprise aluminum or an aluminum alloy.

It is believed that the present disclosure and many of its attendant advantages will be understood by the foregoing description, and it will be apparent that various changes may be made in the form, construction and arrangement of the components thereof without departing from the scope and spirit of the disclosure or without sacrificing all of its material advantages. The form herein before described being merely an explanatory embodiment thereof, it is the intention of the following claims to encompass and include such changes.

What is claimed is:

1. An adjustable hitch insert device comprising:
a plurality of steps, each step of the plurality of steps including two opposing sides;
a first pair of stair supports, each of the first pair of stair supports operably coupled to one opposing side of each of the plurality of steps;
a second pair of stair supports, each of the second pair of stair supports operably coupled to one opposing side of each of the plurality of steps, the second pair of stair supports adjacent the first pair of stair supports; and
a horizontal support member coupled to at least one step of the plurality of steps, the horizontal support member including:
a horizontal support portion; and
an extendable portion configured to move longitudinally relative to the horizontal support portion,
wherein the plurality of steps, the first pair of stair supports, and the second pair of stair supports are configured to transition between a collapsed orientation, where each step of the plurality of steps is in a substantially same plane, and an expanded orientation, where each step of the plurality of steps is in a substantially different plane.

2. The adjustable hitch insert device of claim 1, wherein the horizontal support member includes a first end and a second end, the first end is configured to couple with a hitch of a vehicle.

3. The adjustable hitch insert device of claim 2, wherein the second end is coupled to at least one step of the plurality of steps.

4. The adjustable hitch insert device of claim 2, wherein the first end defines an aperture configured to receive a fastener to couple the horizontal support member with the hitch of the vehicle.

5. The adjustable hitch insert device of claim 1, wherein the plurality of steps includes four steps.

6. The adjustable hitch insert device of claim 1, further comprising:
an interlocking mechanism coupled to one of the first pair of stair supports and to one of the second pair of stair supports.

7. The adjustable hitch insert device of claim 1, further comprising:
a handle mount coupled to one step of the plurality of steps, the handle mount defining an aperture into which a handle is configured to be received.

8. The adjustable hitch insert device of claim 2, wherein when in the expanded orientation, a surface of one step of the plurality of steps is positioned distal to the horizontal support member and is configured to provide a support surface that is in a substantially same plane as a surface of a gate of the vehicle in an open position.

9. The adjustable hitch insert device of claim 1, wherein at least one of the plurality of steps, the first pair of stair supports, the second pair of stair supports, or the horizontal support member comprises at least one of steel, a steel alloy, aluminum, an aluminum alloy, a plastic, or carbon fiber.

10. The adjustable hitch insert device of claim 9, wherein the plurality of steps, the first pair of stair supports, the second pair of stair supports, and the horizontal support member comprise at least one of aluminum or an aluminum alloy.

11. A hitch insert assembly, comprising:
a stair assembly, the stair assembly including:
a plurality of steps, each step of the plurality of steps including two opposing sides, each step of the plurality of steps being positioned in a plane that is different than a plane of the other steps of the plurality of steps; and
a pair of side rails, each of the pair of side rails operably coupled to one opposing side of each of the plurality of steps;
a connector portion coupled to a step of the plurality of steps of the stair assembly, the connector portion being positioned between each side rail or the pair of side rails;
a horizontal support member, the horizontal support member including a first end and a second end, the first end configured for coupling with a hitch of a vehicle, the second end configured for removeably is coupling with the connector portion; and
a handle mount coupled to the stair assembly, the handle mount defining an aperture configured to receive a handle lever.

12. The hitch insert assembly of claim 11, wherein at least one of the connector portion or the horizontal support member defines a tubular shape.

13. The hitch insert assembly of claim 12, wherein the horizontal support member defines a tubular shape, and wherein the connector portion is configured to fit within the tubular shape of the horizontal support member.

14. The hitch insert assembly of claim 12, wherein the connector portion defines a tubular shape, and wherein the horizontal support member is configured to fit within the tubular shape of the connector portion.

15. The hitch insert assembly of claim 11, wherein the handle mount is coupled to one of the pair of side rails.

16. The hitch insert assembly of claim 11, wherein the handle mount is coupled to one of the plurality of steps.

17. The hitch insert assembly of claim 11, wherein the plurality of steps includes four steps.

18. The hitch insert assembly of claim 11, wherein a surface of one step of the plurality of steps is positioned distal to the horizontal support member and is configured to provide a support surface that is in a substantially same plane as a surface of a gate of the vehicle in an open position.

19. The hitch insert assembly of claim 11, wherein at least one step of the plurality of steps includes a slip-resistant surface.

20. The hitch insert assembly of claim 19, wherein the slip resistant surface includes a slip-resistant material coating.
